(19) United States
(12) Patent Application Publication
(10) Pub. No.: US 2015/0326727 A1
(43) Pub. Date: Nov. 12, 2015

(54) DELIVERY OF VISUAL VOICEMAIL OVER MULTIMEDIA MESSAGING SERVICE

(71) Applicant: Microsoft Corporation, Redmond, WA (US)

(72) Inventors: Anish Desai, Bellevue, WA (US); Mahendra Sekaran, Sammamish, WA (US); Vijay Kishen Hampapur Parthasarathy, Sammamish, WA (US); Ruchir Astavans, Redmond, WA (US); Bayo Olatunji, Seattle, WA (US); Clif Gordon, Seattle, WA (US); Gang Li, Sammamish, WA (US); Pradipta Kumar Basu, Redmond, WA (US)

(21) Appl. No.: 14/271,775

(22) Filed: May 7, 2014

(51) Int. Cl. H04M 3/533; H04W 4/14

(52) U.S. Cl. CPC H04M 3/53333; H04W 4/14

(57) ABSTRACT

A visual voicemail (VVM) service uses the MMS (Multimedia Message System) system as a transport mechanism to deliver a voicemail payload to a client VVM application on a mobile device such as a cellular phone or smartphone. The payload is identified as a voicemail using a specific identifier included in a WAP (Wireless Application Protocol) Push message that provides a URL (Uniform Resource Locator) that the VVM client application follows to download the voicemail as an attachment to an MMS message from the VVM service. Regular MMS messages that are not associated with the specific identifier are handled by a conventional messaging application on the mobile device while VVM messages are handled by the client VVM application for presentation in visual form on a user interface supported by the mobile device.

### BACKGROUND

A traditional voicemail system allows a phone user to access his or her voicemail messages by calling a designated number. User's messages are typically stored in a voicemail box in a cloud network and the user calls the voicemail number to listen to messages and interact with the messages (e.g. play, save, delete, etc.). While many voicemail systems perform satisfactorily, opportunities exist to make them more effective with more comprehensive features and benefits to users.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A visual voicemail (VVM) service uses the MMS (Multimedia Message System) system as a transport mechanism to deliver a voicemail payload to a client VVM application on a mobile device such as a cellular phone or smartphone. The payload is identified as a voicemail using a specific identifier included in a WAP (Wireless Application Protocol) Push message that provides a URL (Uniform Resource Locator) that the VVM client application follows to download the voicemail as an attachment to an MMS message from the VVM service. Regular MMS messages that are not associated with the specific identifier are handled by a conventional messaging application on the mobile device while VVM messages are handled by the client VVM application for presentation in visual form on a user interface supported by the mobile device.

In various illustrative embodiments, VVM messages are delivered over MMS to a mobile device that is specially configured to connect to a hybrid telecommunications network using different connection types—for example, Wi-Fi under IEEE 802.11 and cellular voice and data connections. Such mobile device is typically arranged to use the most optimal connection to the hybrid telecommunications network, for example, one that is less expensive, more reliable, higher quality, providing for additional features, etc. The mobile device can also perform handovers between connections on the fly during a communications session with the hybrid network, for example, while on a call or when streaming media content from the Internet, when a more optimal connection becomes available, or if the current network connection degrades below an acceptable level. MMS transport for VVM messages can typically be utilized when the mobile device accesses the hybrid telecommunications network using either a cellular data or Wi-Fi connection. In another illustrative embodiment, VVM messages may be delivered over MMS to mobile devices over a conventional mobile operator network.

Advantageously, the present delivery of VVM messages over MMS can be implemented without the time and expense associated with code development that is needed for typical voicemail messaging solutions. For example, as many mobile devices already support MMS, implementing VVM message transport over MMS can typically be expected to reduce development costs compared to solutions using IMAP (Internet Message Access Protocol) server and client components or other custom protocols.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows an illustrative telecommunications environment in which devices having telephony capabilities communicate over a hybrid telecommunications network;

FIG. 2 shows an illustrative example of connection types over which a particular mobile device may access a hybrid telecommunications network;

FIG. 3 shows an illustrative example in which a call is carried over multiple types of telecommunications networks;

FIG. 4 shows an illustrative example in which a call is handed off between two different networks;

FIG. 5 shows an illustrative layered software architecture used on a mobile device that may be used to implement various aspects of the present delivery of visual voicemail (VVM) over multimedia messaging service (MMS);

FIG. 6 depicts an illustrative graphical user interface (GUI) exposed on a mobile device that shows a notification of a new voicemail message;

FIG. 7 shows an illustrative VVM GUI that shows a list of voicemail messages;

FIG. 8 shows illustrative interactions between a VVM application running on a mobile device and a remote VVM service;

FIG. 9 shows an illustrative MMS message used for VVM transport that includes an encoded audio payload and a VVM identifier;

FIG. 10 is a flowchart of an illustrative method that may be used by the VVM service for generating and sending a VVM message over the MMS system;

FIG. 11 is a flowchart of an illustrative method that may be used at the mobile device for retrieving and notifying a user of an incoming VVM message;

FIG. 12 is a simplified block diagram of an illustrative computer system such as a personal computer (PC) that may be used in part to implement the present delivery of VVM over MMS;

FIG. 13 shows a block diagram of an illustrative device that may be used in part to implement the present delivery of VVM over MMS; and

FIG. 14 is a block diagram of an illustrative mobile device.

Like reference numerals indicate like elements in the drawings. Elements are not drawn to scale unless otherwise indicated.

### DETAILED DESCRIPTION

A visual voicemail (VVM) system typically enables a mobile device user to see his or her voicemail messages visually in a list and provides access to the messages in any order. Typically, in a VVM system, audio messages are downloaded onto a mobile device such as a cell phone or smartphone and stored locally. Once the messages are retrieved and stored, the user is able to play and interact with them.

There are a variety of different ways in which VVMs can be downloaded onto the phone. For example, some conventional VVM systems can deliver voicemail messages to the phone using IMAP which is the same protocol used to download emails onto the phone from email servers supporting IMAP. Other conventional VVM systems deliver voicemail messages to the phone using one or more custom protocols. These delivery mechanisms used by conventional VVM systems typically necessitate the development of additional hardware and software components in services used in network cloud implementations along with the development of additional software components on the phone. For example, a VVM system using IMAP to deliver messages to the phone means that an IMAP server needs to be implemented in the cloud and an IMAP client needs to be implemented on the phone.

The present VVM system repurposes the MMS (Multimedia Messaging System) system to be used for voicemail transport between a voicemail system and the mobile device over connections to a hybrid telecommunications network.

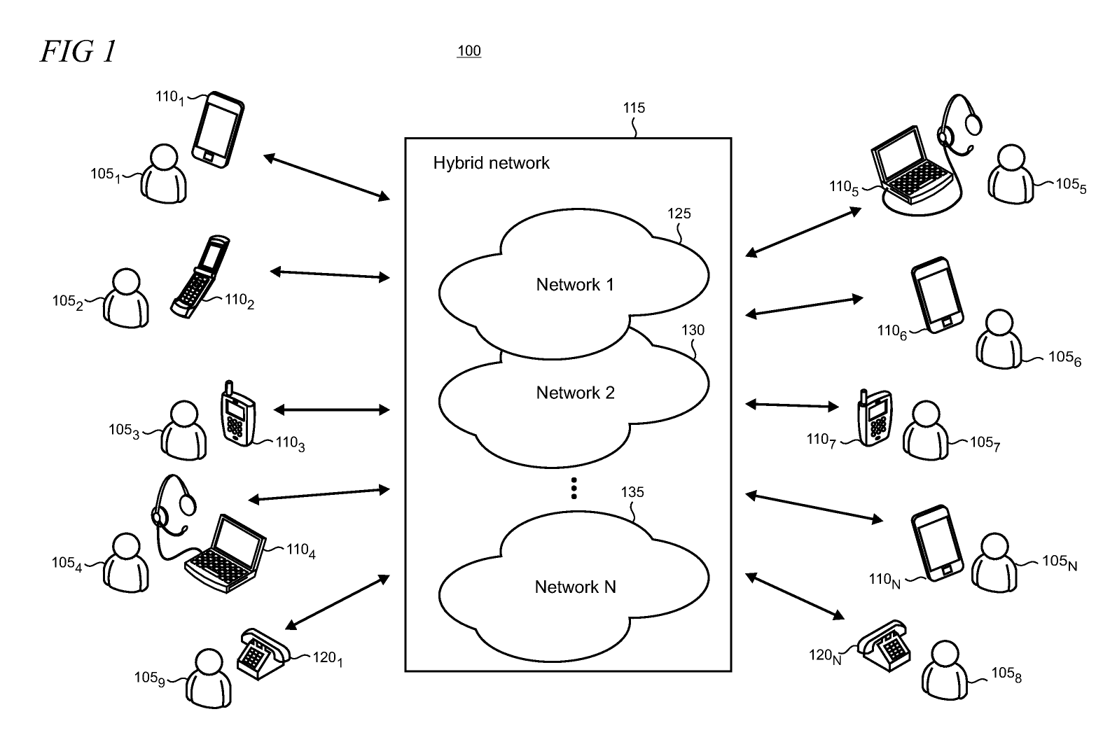

Turning now to the drawings, FIG. 1 shows an illustrative telecommunications environment 100 in which various users 105 employ respective devices 110 that communicate over a hybrid telecommunications network 115. The devices 110 provide voice telephony capabilities and typically support data-consuming applications such as Internet browsing and multimedia (e.g., music, video, etc.) consumption in addition to various other features. The devices 110 may include, for example, user equipment, mobile phones, cell phones, and smartphones which users often employ to make and receive voice and/or multimedia calls. However, alternative types of electronic devices are also envisioned to be usable within the telecommunications environment 100 so long as they are configured with telephony capabilities and can connect to the hybrid telecommunications network 115, as described in more detail below. Such alternative devices variously include handheld computing devices, PDAs, portable media players, wearable computers, navigation devices such as GPS (Global Positioning System) systems, laptop PCs (personal computers), desktop computers, multimedia consoles, gaming systems, or the like. In the discussion that follows, the use of the term “mobile device” is intended to cover all devices that are configured with telephony capabilities and are capable of wireless connectivity to the hybrid telecommunications network 115.

Other types of telephony equipment may also be present in the telecommunications environment 100 such as conventional desktop phones 120 which are operatively coupled to a public switched telephone network (PSTN). Other examples may include equipment that connects to the PSTN using private branch exchanges (PBXs) and equipment coupled to call services that are accessed using telephone numbers. This other telephony equipment may still be utilized in various scenarios involving call handoff and/or delivery of VVM over MMS. For example, a mobile phone 110 may make or receive a call to a desktop phone 120 and employ voice call continuity (as described in more detail below) as the prevailing connection conditions change such as when the mobile device user moves from a car to home during a call. The desktop phone 120 could also be used to place a call to a mobile device and leave a voicemail message if the mobile device user does not answer.

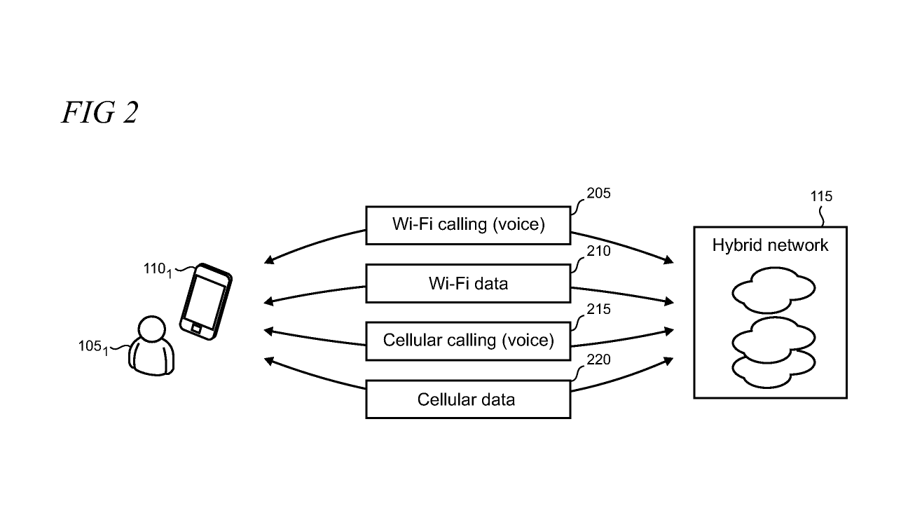

The hybrid telecommunications network 115 comprises several networks 1, 2 . . . N, identified in FIG. 1 by reference numerals 125, 130, and 135, respectively. Typically, the various networks will be accessed using different types of wireless connections. For example, as shown in FIG. 2, the connection types may illustratively include Wi-Fi calling 205 (i.e., Wi-Fi voice), Wi-Fi data 210, cellular calling 215 (i.e., cellular voice), and cellular data 220. Thus, the networks in the hybrid telecommunications network 115 may include a VoIP network and a mobile operator (MO) network which typically includes an access network portion and a core network portion that provides for switching, routing, transport, and other functionalities. A PSTN wireline network may also be included as part of the hybrid telecommunications network in some implementations, as discussed in more detail below.

Each mobile device 110 will typically have a prearranged association with one or more of the networks underlying the hybrid telecommunications network 115. For example, a user 105 will typically be a subscriber to a cellular telephone service so that the user's mobile device 110 can access a given cellular network as valid and authenticated user equipment. Similarly, the mobile device 110 may include functionality and credentials to access a Wi-Fi network. The mobile devices 110 may also interoperate with a VoIP network and be capable of providing voice call continuity (VCC) across different connection types according to a prearranged association. Such mobile devices are considered “VCC-equipped” and can access the hybrid telecommunications network 115 over the different types of connections.

In some situations, a mobile device may be placed in a dock or cradle that is coupled to the PSTN and thus could employ a wireline connection for a call which is often the least expensive network connection. Typically, the mobile devices 110 use the less expensive Wi-Fi connection whenever it is available and capable of providing a reasonable level of call quality. When Wi-Fi is not available or is inadequate for the voice call, the call may be made over one of the other available network connection options after determining that the selected connection will result in acceptable call quality. Cellular voice is typically the costliest connection alternative but also the most ubiquitous and so it is used to ensure that the user has access to calling services from as wide an area as possible. In the description that follows, the mobile devices 110 are considered to be VCC equipped unless otherwise indicated.

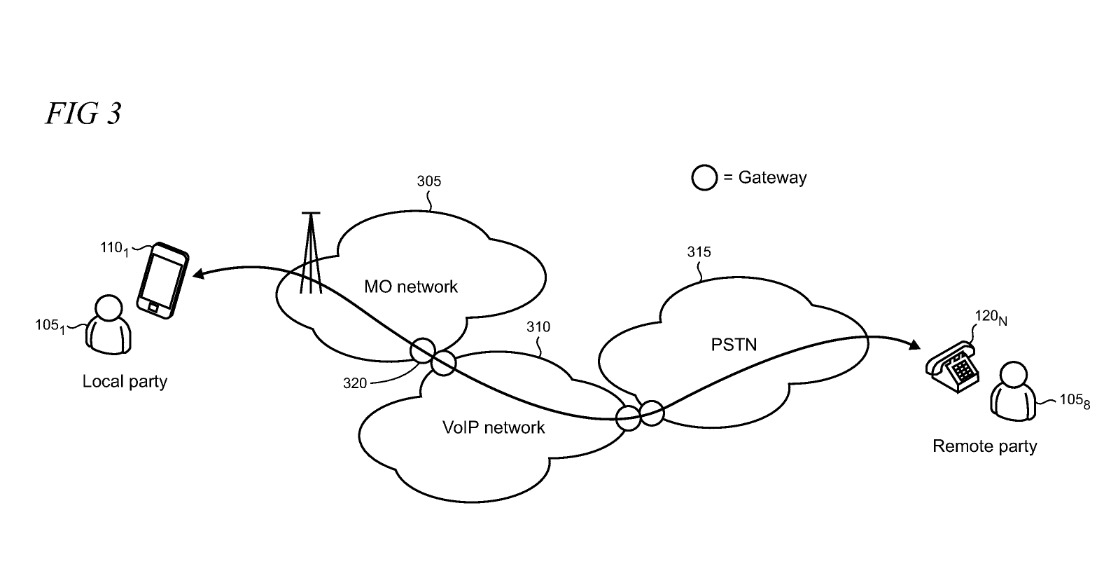

A characteristic of the hybrid telecommunications network 115 is that two or more of the underlying networks (e.g., networks 125, 130, 135) are considered loosely coupled. That is, in one illustrative example, the VoIP network and the MO network are typically operated independently so that one network cannot exercise significant or substantial control over the operation of the other. However, as shown in FIG. 3, the underlying networks, while loosely coupled, are still interoperable so that calls can traverse an MO network 305, VoIP network 310, and PSTN 315. Such interoperability is commonly facilitated using gateways, as representatively indicated by reference numeral 320. It is becoming increasingly common for significant portions of a given call to be transported over the VoIP network 310 because such networks can often provide very high quality transportation at the lowest cost to the network operators. In such cases, the MO network 305 and the PSTN network 315 essentially function as access networks to the mobile device at each end of the call while the VoIP network 310 performs the bulk of the routing and transport for the call. Other access networks may also be utilized in order for a call to reach the VoIP network 310 including both cellular circuit-switched and packet-switched networks, and Wi-Fi access points (APs) such as public Wi-Fi “hotspots” and those provided by home and office Internet Service Providers (ISPs).

While such hybridization can provide cost-effective and high quality transport, the loose coupling has traditionally presented difficulties for voice call continuity. Voice call continuity functionality is defined here as the maintenance of ongoing voice calls for a device that is capable of placing and receiving voice calls in the face of changes in prevailing connection conditions perhaps due to user mobility or other environmental factors. For example, the connection currently being used, such as Wi-Fi under IEEE (Institute of Electrical and Electronic Engineers) 802.11 could start demonstrating worsening radio signal and/or network congestion conditions, or the user could move to a location where the Wi-Fi connection does not work at all. In addition, other connection options may become available that are lower cost, or provide a better user experience, and therefore either or both the user and network operator may wish to utilize such connection options.

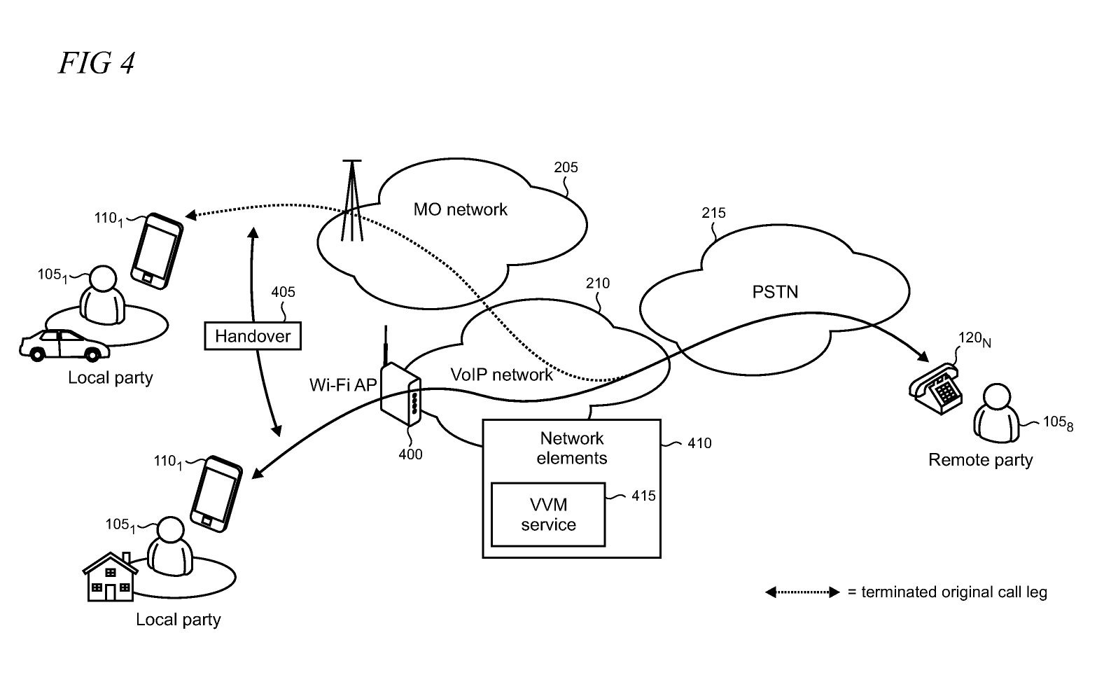

For example, as shown in FIG. 4, a user 105 may be in the car when initiating a call over the MO network 305. When the user 105 returns home, another call leg is then created over a selected connection which in this example is the home Wi-Fi connection via a Wi-Fi AP 400 to the VoIP network 310. The selected connection is associated with the call, preferably while the original call is still ongoing (in what is termed a “make-before-break” handoff). When the new call leg is stable, the original call leg is removed from the call and the handoff 405 to the new connection is complete.

If the handoff is initiated so that both the original and newly selected connections are operative simultaneously then there will be an intermediate state in which both call legs will be running in parallel. Media flows can be directed to and from the mobile device over these parallel connections, until one of the two flows is terminated. Such intermediate state enables the call to be maintained in an uninterrupted manner as perceived by the parties on both ends of the call. During the intermediate state, the mobile device can typically choose to connect to one of the two flows as it deems appropriate.

FIG. 4 also shows network elements 410 that are instantiated in the VoIP network 210. The network elements 410 can be configured and utilized to support various features in the hybrid telecommunications network including, for example, delivery of VVM over MMS. In addition, the network elements 410 can expose a VVM service 415 that is described in more detail below.

In alternative implementations, a conventional MO network (i.e., a non-hybrid telecommunications network) may be utilized to provide voice and data services to the mobile device 110. In such implementations, the VVM service can be instantiated in network elements located in the MO network.

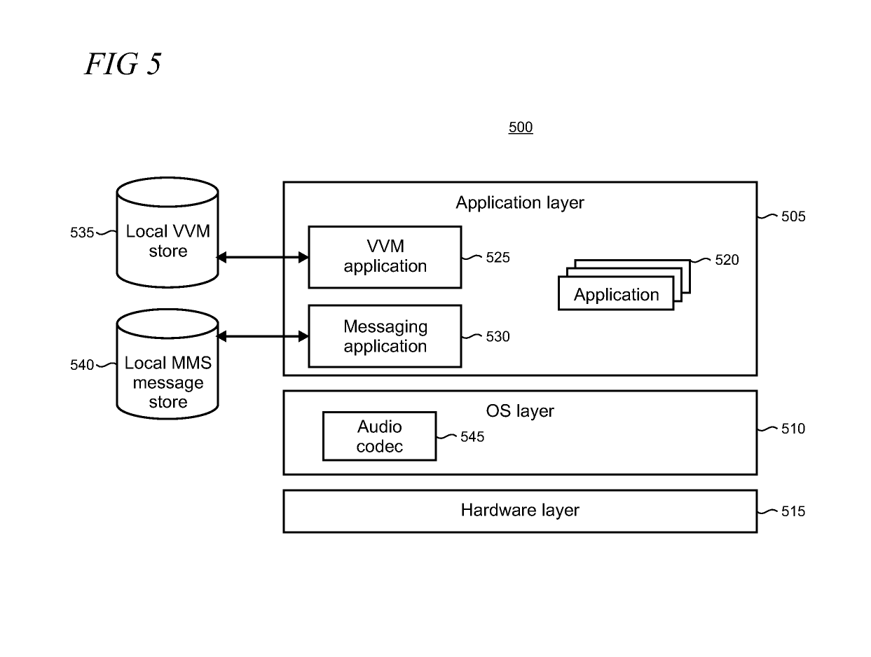

As shown in FIG. 5, a mobile device 110 can support a layered architecture 500 of functional components. The architecture 500 is typically implemented in software, although combinations of software, firmware, and/or hardware may also be utilized in some cases. The architecture 500 is arranged in layers and includes an application layer 505, an OS (operating system) layer 510, and a hardware layer 515. The hardware layer 515 provides an abstraction of the various hardware used by the mobile device 110 (e.g., input and output devices, networking and radio hardware, etc.) to the layers above it.

In addition to supporting various functional components (not shown) the OS layer 510 includes one or more audio codecs (coder/decoder) as representatively shown by audio codec 545. Audio codec 545 is typically configured for encoding and decoding digital media files, including audio, for example as part of efficient bandwidth utilization techniques such as file compression/decompression.

The application layer 505 in this illustrative example supports various applications 520 as well as a VVM application 525 and messaging application 530. The applications 520, 525, and 530 are often implemented using locally executing code. However in some cases the applications may rely on services and/or remote code execution provided by remote servers or other computing platforms such as those supported by an external service provider. The VVM application 525 and messaging application 530 are arranged to respectively access a local VVM store 535 and local MMS message store 540, as shown. While the VVM application 525 is shown here as a component that is instantiated in the application layer 505, it will be appreciated that the functionality provided by the application may be implemented, in whole or part, using components that are supported in either the OS or hardware layers.

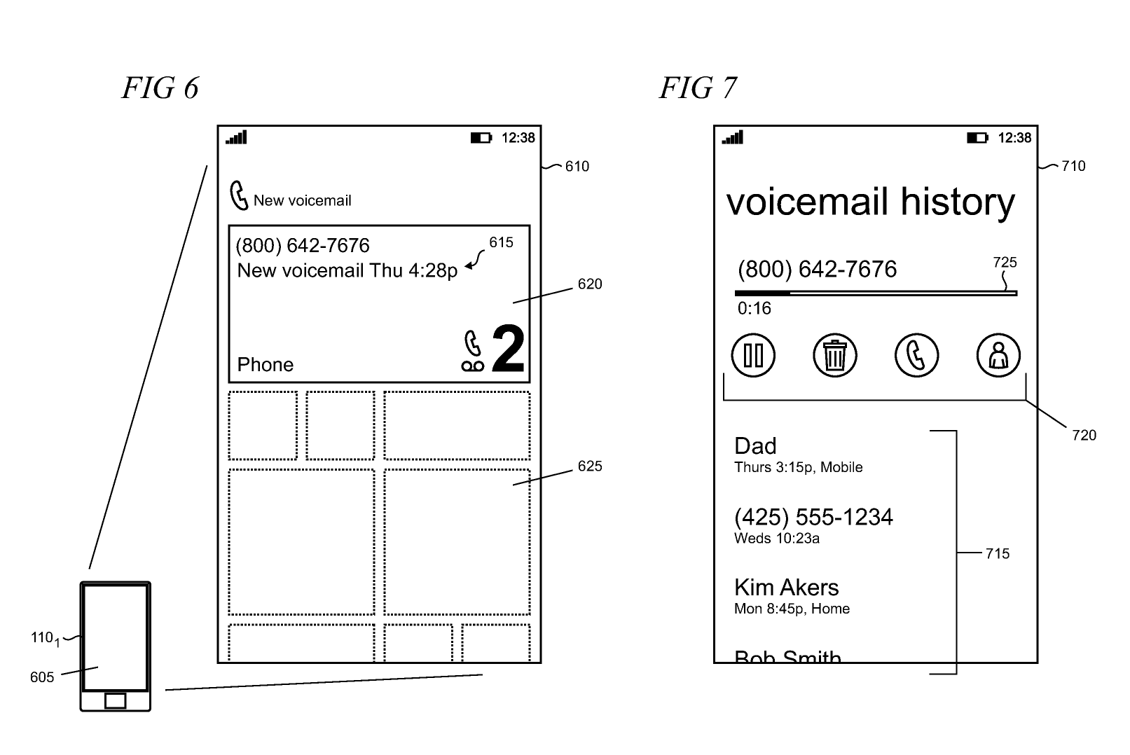

The VVM application 525 is typically arranged to render into a graphical user interface (GUI) supported on the mobile device's display screen. For example, as shown in FIG. 6, the display screen 605, which may be configured as a touchscreen in typical applications, supports a GUI 610 that shows an illustrative example of a new voicemail notification that is provided by the VVM application 525. In this example, the notification 615 is displayed on the mobile device's phone tile 620 which is shown on the display along with other tiles (representatively indicated by reference numeral 625) that are associated with other user experiences supported on the mobile device 110.

FIG. 7 depicts a typical VVM GUI 710 in which a list 715 of voicemail messages is shown to the user. The voicemail list 715 can be configured to be scrollable so that the user can swipe the touchscreen 605 to reveal additional voicemail messages, as shown. In this particular example, the user has selected the most recent voicemail for playback through the mobile device's audio endpoint (not shown) such as the device's internal speaker, a wired or wireless headset/earpiece, and the like. Various options are exposed to the user through the GUI 710 using touch controls 720 such as pause, delete, call back, and messaging. In some cases, the user can scrub the timeline 725 to skip ahead or go back in the voicemail recording.

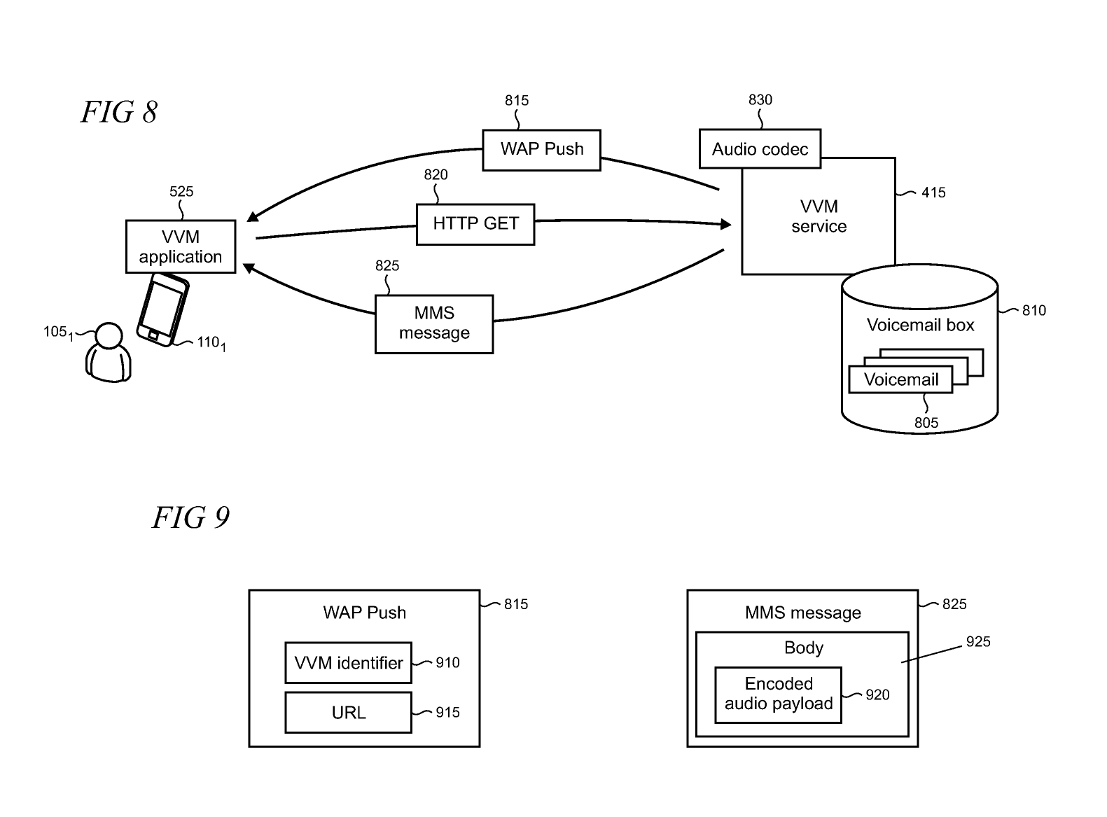

FIG. 8 shows illustrative interactions between the VVM application 525 running on a mobile device 110 and the VVM service 415 in which VVM messages are transported over MMS. MMS transport can typically be utilized for VVM messages the mobile device 110 accesses the service 415 in the hybrid telecommunications network using either a cellular data or Wi-Fi connection.

Voicemail messages 805 are stored in a voicemail box 810 that is associated with the user 105. When a new voicemail for the user 105 is deposited in the mailbox, the VVM service 415 sends a notification to the mobile device 110 using a WAP (Wireless Application Protocol) Push 815 over the SMS (Short Message Service) protocol that provides a link using a URL (Universal Resource Locator) pointer to the stored voicemail message. The VVM application 525 uses an HTTP (Hypertext Transfer Protocol) GET 820 to request the stored voicemail message. In response to the GET request, the VVM service 415 sends an MMS message 825 to the VVM application 525. HTTPS (Hypertext Transfer Protocol Secure) may also be utilized for downloading the voicemail message in some cases.

As shown in FIG. 9, the WAP Push 815 includes a specific VVM identifier 910 and a URL 915 that identifies a location from which the MMS message 825 can be downloaded. The MMS message 825 includes a payload 920 that represents the audio content of the voicemail message that is included in the body 925 of the message as an attachment. The MMS header (not shown) consists of address, priority, subject, and delivery information. The audio content of the voicemail message is encoded using an audio codec 830 shown in FIG. 8 so that it can be decoded by the corresponding audio codec 545 (FIG. 5) that is operable on the mobile device.

The specific identifier 910 for the VVM message 905 is utilized to identify the MMS message 825 as a VVM message to the VVM application 525 running on the mobile device 110. In this particular illustrative example, the specific VVM identifier is stored in an existing field that is supported by the WAP Push, specifically the “from” field contained in the SMS message header. Other header fields or other storage mechanisms can be utilized in alternative implementations to store the specific identifier that can be used to identify the MMS message as containing a voicemail audio payload.

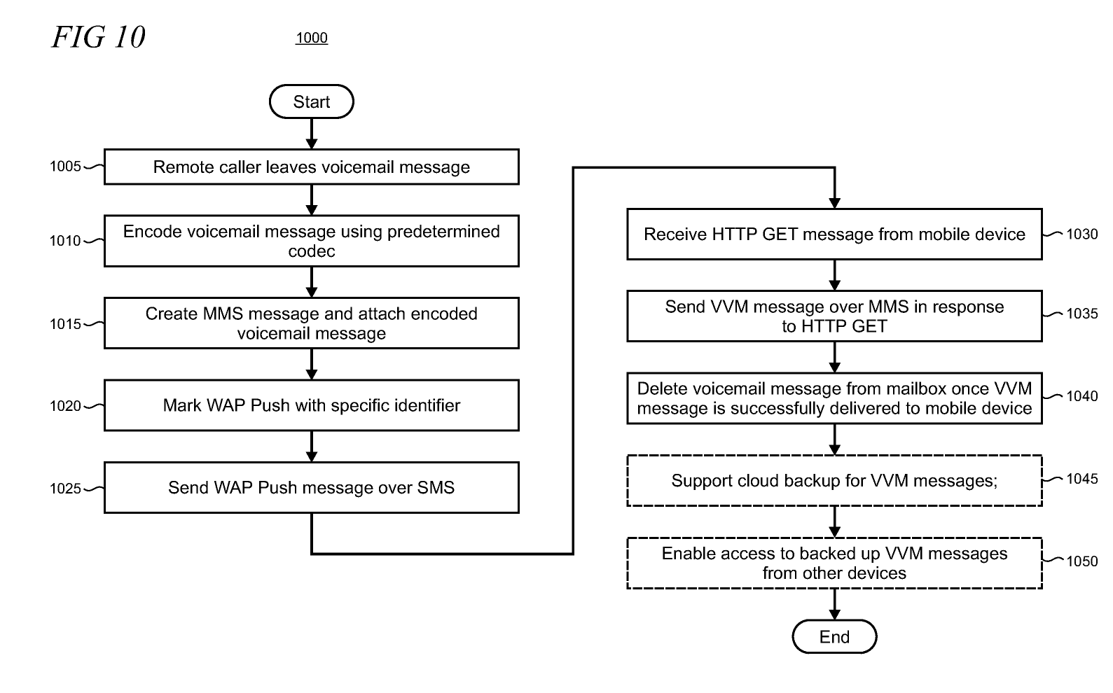

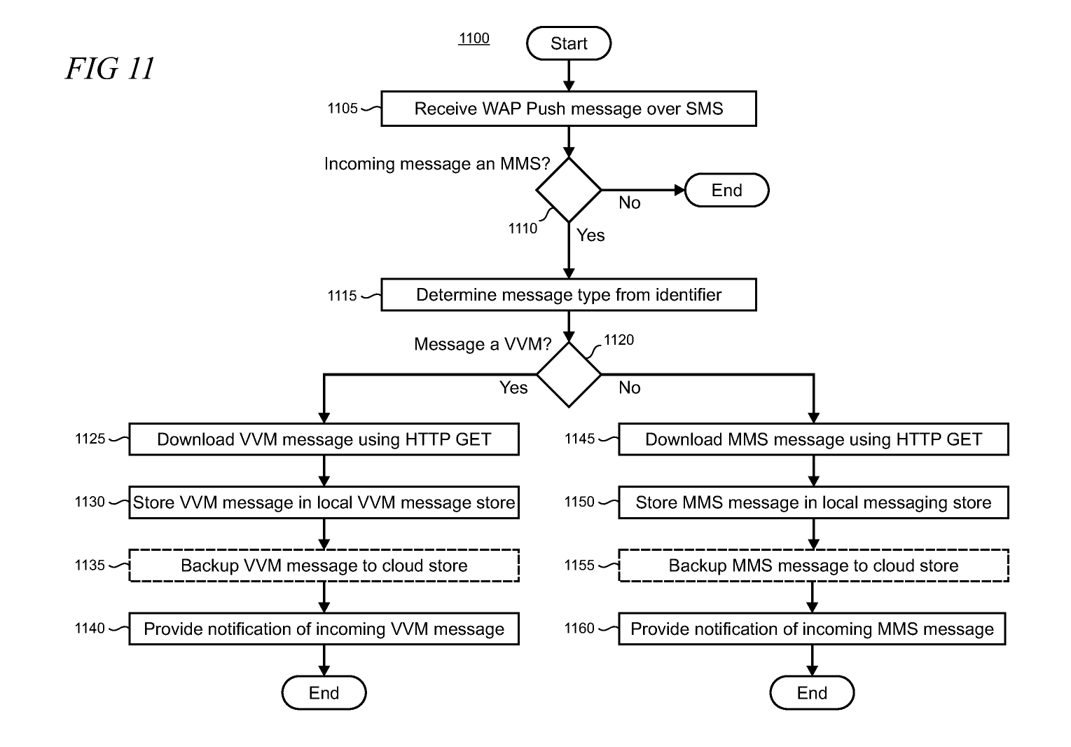

FIG. 10 is a flowchart of an illustrative method 1000 used by the VVM service 415 (FIG. 4) for generating and sending a VVM message over the MMS protocol. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1005, a remote caller leaves a voicemail message for a local user of a mobile device. The voicemail message audio is encoded using a codec that the mobile device is known to be able to decode in step 1010. In step 1015, the encoded audio is attached to an MMS message as a payload. A WAP Push message is marked with a specific identifier in step 1020 using the “from” field in the message header to indicate to the client VVM application that the MMS message includes a VVM message.

The VVM service sends a WAP Push message including the specific identifier over SMS to the client VVM application on the mobile device in step 1025. When the VVM service receives an HTTP GET (or HTTPS GET) message from the mobile device in step 1030, it responsively sends the VVM message over MMS in step 1035. As described above, both the notification and message delivery can be performed over either type of connection (i.e., a Wi-Fi or cellular data connection) between the mobile device and the hybrid telecommunications network.

The voicemail message can be deleted from the voicemail box in step 1040 once the VVM message has been successfully delivered to the mobile device.

The VVM service can be optionally configured (as indicated by the dashed rectangle in step 1045) to support remote or cloud-based backup by the mobile device for VVM messages in some implementations. Typically, such feature can be enabled in scenarios in which the mobile device also has capabilities for backing up MMS messages. The VVM service can enable backed up VVM messages to be optionally accessed from other devices in step 1050.

FIG. 11 is a flowchart of an illustrative method 1100 used at the mobile device for retrieving and notifying a user of an incoming VVM message. In step 1105, the client VVM application on the mobile device receives a WAP Push message including the specific identifier over SMS.

At decision block 1110, if the notification does not pertain to an MMS message, the method ends, otherwise, the method continues in step 1115. If the notification deals with an MMS message, it will contain header information about the MMS message and a URL pointer to the MMS content. The VVM application determines the MMS message type by determining if the WAP Push includes the specific identifier that indicates that the message contains a VVM message payload in step 1115. At decision block 1120, if the MMS message is a VVM message, then control passes to step 1125 where the VVM application downloads the body of the MMS message using HTTP GET. In some cases, the user may be provided with an option to attempt to download the MMS message body again if, for some reason, an earlier download attempts fails. The downloading may be performed using the HTTP GET method or HTTPS GET in some cases. The VVM application stores the downloaded VVM message in the local VVM message store on the mobile device in step 1130.

In step 1135, the VVM application can optionally backup VVM messages to a remote or cloud-based store, as indicated by the dashed rectangle in FIG. 11. As noted above, such feature can typically be supported particularly when, for example, the mobile device is equipped with regular MMS message backup capabilities. In step 1140, the VVM application triggers a notification to the user of the mobile device of the new incoming VVM message. For example, the notification can be displayed on the device's phone tile as shown in FIG. 6 and described in the accompanying text.

At decision block 1120, if the MMS message is not a VVM message (i.e., it is a regular MMS message), then control passes to step 1145. Steps 1145-1160 in FIG. 11 can be performed by a conventional messaging application that runs on the mobile device in typical implementations. Alternatively, some or all of those steps may be performed by the VVM application in some cases.

In step 1145, the MMS message body is downloaded (e.g., using HTTP GET or HTTPS GET) and stored in the local messaging store in step 1150. Cloud backup for MMS messages can be optionally provided in step 1155. A notification of the new incoming MMS message is provided in step 1160.

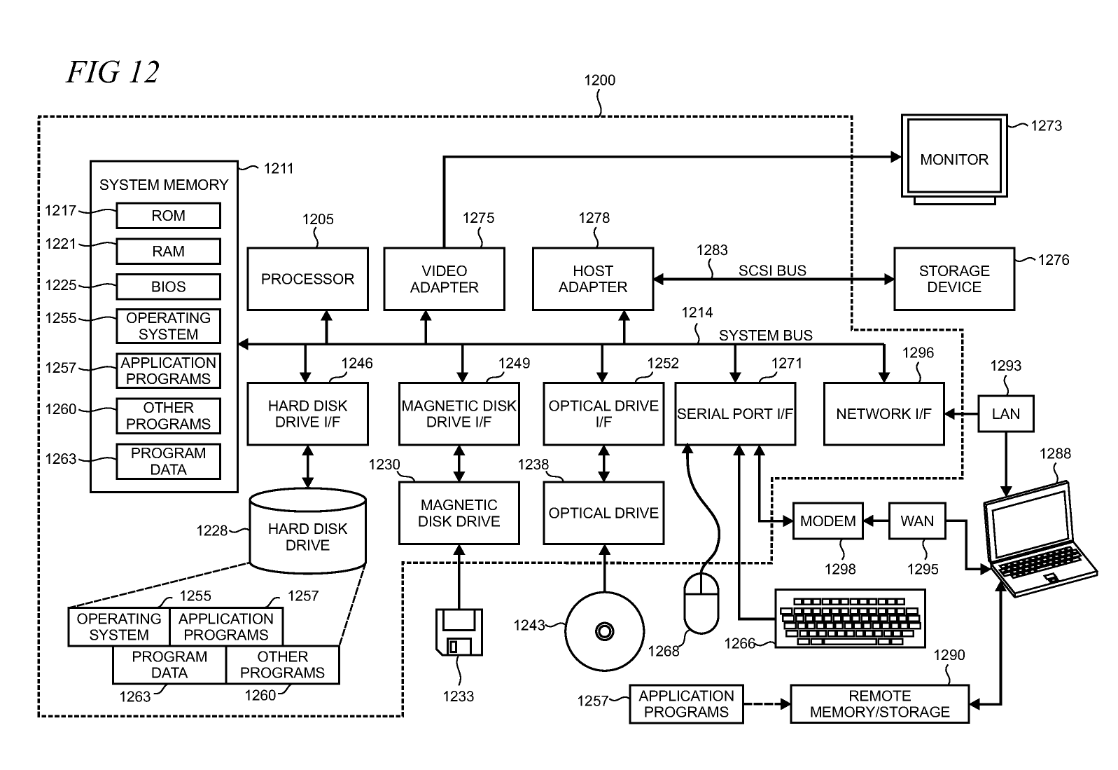

FIG. 12 is a simplified block diagram of an illustrative computer system 1200 such as a personal computer (PC), client machine, or server with which the delivery of VVM over MMS may be implemented. Computer system 1200 includes a processor 1205, a system memory 1211, and a system bus 1214 that couples various system components including the system memory 1211 to the processor 1205. The system bus 1214 may be any of several types of bus structures including a memory bus or memory controller, a peripheral bus, or a local bus using any of a variety of bus architectures. The system memory 1211 includes read only memory (ROM) 1217 and random access memory (RAM) 1221. A basic input/output system (BIOS) 1225, containing the basic routines that help to transfer information between elements within the computer system 1200, such as during startup, is stored in ROM 1217. The computer system 1200 may further include a hard disk drive 1228 for reading from and writing to an internally disposed hard disk (not shown), a magnetic disk drive 1230 for reading from or writing to a removable magnetic disk 1233 (e.g., a floppy disk), and an optical disk drive 1238 for reading from or writing to a removable optical disk 1243 such as a CD (compact disc), DVD (digital versatile disc), or other optical media. The hard disk drive 1228, magnetic disk drive 1230, and optical disk drive 1238 are connected to the system bus 1214 by a hard disk drive interface 1246, a magnetic disk drive interface 1249, and an optical drive interface 1252, respectively. The drives and their associated computer-readable storage media provide non-volatile storage of computer-readable instructions, data structures, program modules, and other data for the computer system 1200. Although this illustrative example includes a hard disk, a removable magnetic disk 1233, and a removable optical disk 1243, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present delivery of VVM over MMS. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk 1228, magnetic disk 1233, optical disk 1243, ROM 1217, or RAM 1221, including an operating system 1255, one or more application programs 1257, other program modules 1260, and program data 1263. A user may enter commands and information into the computer system 1200 through input devices such as a keyboard 1266 and pointing device 1268 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 1205 through a serial port interface 1271 that is coupled to the system bus 1214, but may be connected by other interfaces, such as a parallel port, game port, or universal serial bus (USB). A monitor 1273 or other type of display device is also connected to the system bus 1214 via an interface, such as a video adapter 1275. In addition to the monitor 1273, personal computers typically include other peripheral output devices (not shown), such as speakers and printers. The illustrative example shown in FIG. 12 also includes a host adapter 1278, a Small Computer System Interface (SCSI) bus 1283, and an external storage device 1276 connected to the SCSI bus 1283.

The computer system 1200 is operable in a networked environment using logical connections to one or more remote computers, such as a remote computer 1288. The remote computer 1288 may be selected as another personal computer, a server, a router, a network PC, a peer device, or other common network node, and typically includes many or all of the elements described above relative to the computer system 1200, although only a single representative remote memory/storage device 1290 is shown in FIG. 12. The logical connections depicted in FIG. 12 include a local area network (LAN) 1293 and a wide area network (WAN) 1295. Such networking environments are often deployed, for example, in offices, enterprise-wide computer networks, intranets, and the Internet.

When used in a LAN networking environment, the computer system 1200 is connected to the local area network 1293 through a network interface or adapter 1296. When used in a WAN networking environment, the computer system 1200 typically includes a broadband modem 1298, network gateway, or other means for establishing communications over the wide area network 1295, such as the Internet. The broadband modem 1298, which may be internal or external, is connected to the system bus 1214 via a serial port interface 1271. In a networked environment, program modules related to the computer system 1200, or portions thereof, may be stored in the remote memory storage device 1290. It is noted that the network connections shown in FIG. 12 are illustrative and other means of establishing a communications link between the computers may be used depending on the specific requirements of an application of the present delivery of VVM over MMS.

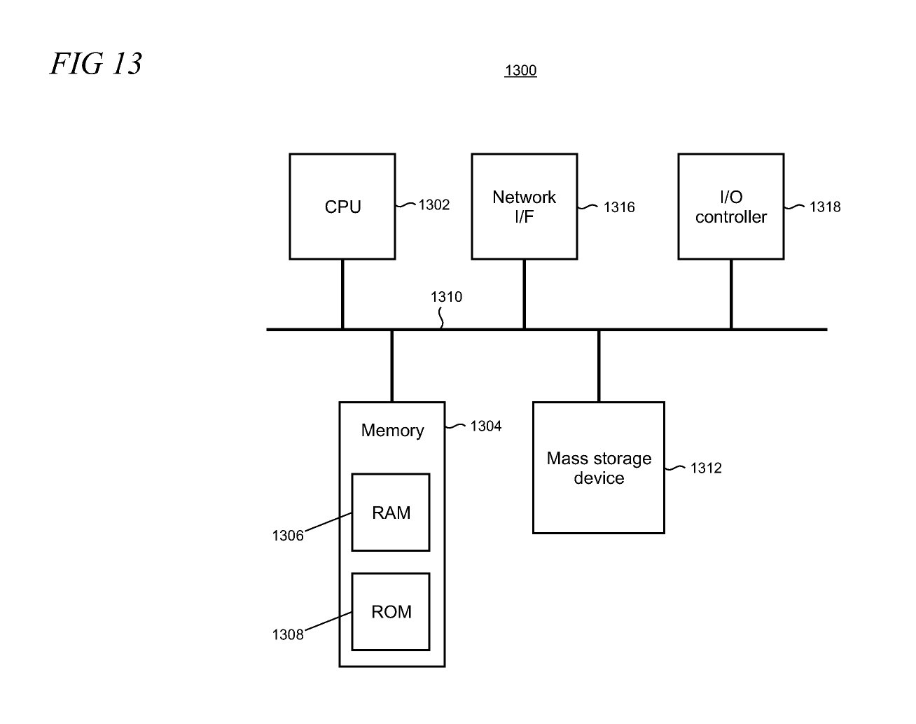

FIG. 13 shows an illustrative architecture 1300 for a device capable of executing the various components described herein for providing the present delivery of VVM over MMS. Thus, the architecture 1300 illustrated in FIG. 13 shows an architecture that may be adapted for a server computer, mobile phone, a PDA, a smartphone, a desktop computer, a netbook computer, a tablet computer, GPS device, gaming console, and/or a laptop computer. The architecture 1300 may be utilized to execute any aspect of the components presented herein.

The architecture 1300 illustrated in FIG. 13 includes a CPU 1302, a system memory 1304, including a RAM 1306 and a ROM 1308, and a system bus 1310 that couples the memory 1304 to the CPU 1302. A basic input/output system containing the basic routines that help to transfer information between elements within the architecture 1300, such as during startup, is stored in the ROM 1308. The architecture 1300 further includes a mass storage device 1312 for storing software code or other computer-executed code that is utilized to implement applications, the file system, and the operating system.

The mass storage device 1312 is connected to the CPU 1302 through a mass storage controller (not shown) connected to the bus 1310. The mass storage device 1312 and its associated computer-readable storage media provide non-volatile storage for the architecture 1300.

Although the description of computer-readable storage media contained herein refers to a mass storage device, such as a hard disk or CD-ROM drive, it should be appreciated by those skilled in the art that computer-readable storage media can be any available storage media that can be accessed by the architecture 1300.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1300.

According to various embodiments, the architecture 1300 may operate in a networked environment using logical connections to remote computers through a network. The architecture 1300 may connect to the network through a network interface unit 1316 connected to the bus 1310. It should be appreciated that the network interface unit 1316 also may be utilized to connect to other types of networks and remote computer systems. The architecture 1300 also may include an input/output controller 1318 for receiving and processing input from a number of other devices, including a keyboard, mouse, or electronic stylus (not shown in FIG. 13). Similarly, the input/output controller 1318 may provide output to a display screen, a printer, or other type of output device (also not shown in FIG. 13).

It should be appreciated that the software components described herein may, when loaded into the CPU 1302 and executed, transform the CPU 1302 and the overall architecture 1300 from a general-purpose computing system into a special-purpose computing system customized to facilitate the functionality presented herein. The CPU 1302 may be constructed from any number of transistors or other discrete circuit elements, which may individually or collectively assume any number of states. More specifically, the CPU 1302 may operate as a finite-state machine, in response to executable instructions contained within the software modules disclosed herein. These computer-executable instructions may transform the CPU 1302 by specifying how the CPU 1302 transitions between states, thereby transforming the transistors or other discrete hardware elements constituting the CPU 1302.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 1300 in order to store and execute the software components presented herein. It also should be appreciated that the architecture 1300 may include other types of computing devices, including handheld computers, embedded computer systems, smartphones, PDAs, and other types of computing devices known to those skilled in the art. It is also contemplated that the architecture 1300 may not include all of the components shown in FIG. 13, may include other components that are not explicitly shown in FIG. 13, or may utilize an architecture completely different from that shown in FIG. 13.

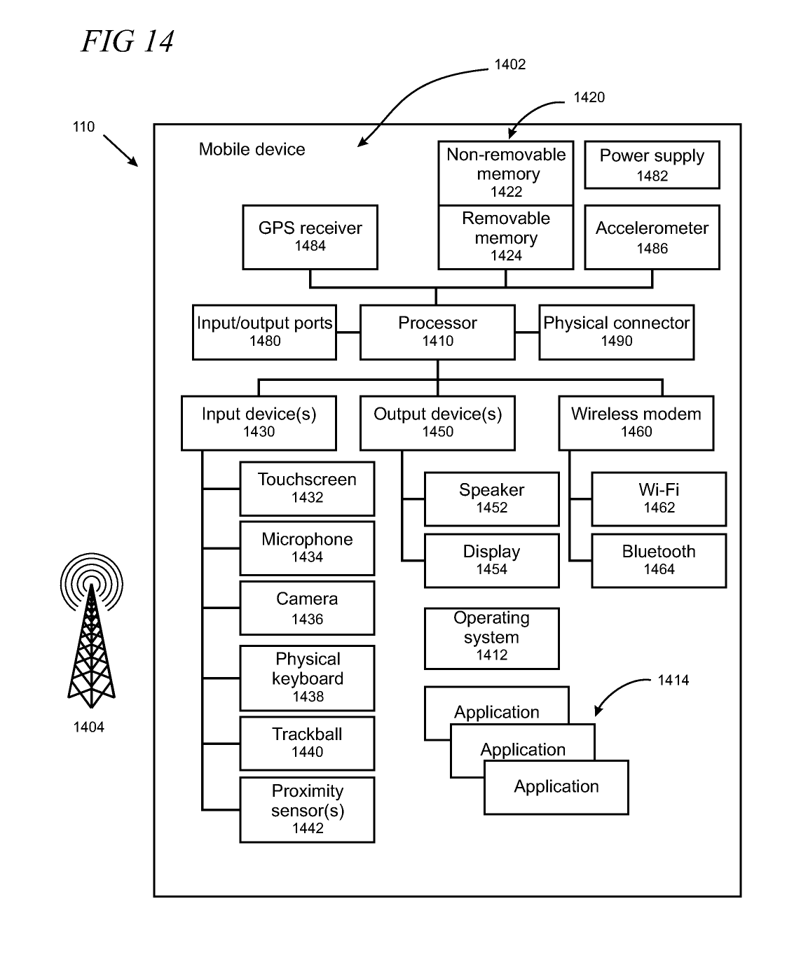

FIG. 14 is a functional block diagram of an illustrative mobile device 110 such as a mobile phone or smartphone including a variety of optional hardware and software components, shown generally at 1402. Any component 1402 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 1404, such as a cellular or satellite network.

The illustrated mobile device 110 can include a controller or processor 1410 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 1412 can control the allocation and usage of the components 1402, including power states, above-lock states, and below-lock states, and provides support for one or more application programs 1414. The application programs can include common mobile computing applications (e.g., image-capture applications, email applications, calendars, contact managers, web browsers, messaging applications), or any other computing application.

The illustrated mobile device 110 can include memory 1420. Memory 1420 can include non-removable memory 1422 and/or removable memory 1424. The non-removable memory 1422 can include RAM, ROM, Flash memory, a hard disk, or other well-known memory storage technologies. The removable memory 1424 can include Flash memory or a Subscriber Identity Module (SIM) card, which is well known in GSM (Global System for Mobile communications) systems, or other well-known memory storage technologies, such as “smart cards.” The memory 1420 can be used for storing data and/or code for running the operating system 1412 and the application programs 1414. Example data can include web pages, text, images, sound files, video data, or other data sets to be sent to and/or received from one or more network servers or other devices via one or more wired or wireless networks.

The memory 1420 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the mobile device 110.

The memory 1420 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The mobile device 110 can support one or more input devices 1430; such as a touch screen 1432; microphone 1434 for implementation of voice input for voice recognition, voice commands and the like; camera 1436; physical keyboard 1438; trackball 1440; and/or proximity sensor 1442; and one or more output devices 1450, such as a speaker 1452 and one or more displays 1454. Other input devices (not shown) using gesture recognition may also be utilized in some cases. Other possible output devices (not shown) can include piezoelectric or haptic output devices. Some devices can serve more than one input/output function. For example, touchscreen 1432 and display 1454 can be combined into a single input/output device.

A wireless modem 1460 can be coupled to an antenna (not shown) and can support two-way communications between the processor 1410 and external devices, as is well understood in the art. The modem 1460 is shown generically and can include a cellular modem for communicating with the mobile communication network 1404 and/or other radio-based modems (e.g., Bluetooth 1464 or Wi-Fi 1462). The wireless modem 1460 is typically configured for communication with one or more cellular networks, such as a GSM network for data and voice communications within a single cellular network, between cellular networks, or between the mobile device and a public switched telephone network (PSTN).

The mobile device can further include at least one input/output port 1480, a power supply 1482, a satellite navigation system receiver 1484, such as a GPS receiver, an accelerometer 1486, a gyroscope (not shown), and/or a physical connector 1490, which can be a USB port, IEEE 1394 (FireWire) port, and/or an RS-232 port. The illustrated components 1402 are not required or all-inclusive, as any components can be deleted and other components can be added.

Based on the foregoing, it should be appreciated that technologies for delivery of VVM over MMS have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A computer-implemented method for delivering voicemail messages from a service to a mobile device, comprising:
receiving a voicemail message for a user associated with the mobile device;
providing a notification executing on the mobile device of the voicemail message, the notification being incorporated in a WAP (Wireless Application Protocol) Push message that includes a header and a link to MMS content, the header including an identifier for flagging an MMS message as including a voicemail message payload; and
in response to a request, sending the MMS message including the voicemail message payload to the mobile device.

2. The computer-implemented method of claim 1 further including encoding the voicemail payload using an audio codec that is capable of being decoded by the mobile device.

3. The computer-implemented method of claim 1 further including using the “from” field in the WAP Push message header to store the identifier.

4. The computer-implemented method of claim 1 further including deleting the voicemail message from storage after the MMS message has been delivered to the mobile device.

5. The computer-implemented method of claim 1 further including using the MMS message to carry the voicemail message payload as an attachment.

6. The computer-implemented method of claim 1 further including sending the WAP Push message over SMS (Short Message Service).

7. The computer-implemented method of claim 1 further including one of i) sending the notification and MMS message over one or more different connections between the mobile device and hybrid telecommunications network, the one or more different connections comprising a Wi-Fi connection and a cellular data connection, the hybrid telecommunications network comprising loosely coupled network portions, the network portions including at least a mobile operator network and a VoIP (Voice over Internet Protocol) network or ii) sending the notification and MMS message over a mobile operator network.

8. The computer-implemented method of claim 1 in which the request comprises an HTTP (Hypertext Transfer Protocol) GET message or HTTPS (Hypertext Transfer Protocol Secure) GET message.

9. The computer-implemented method of claim 1 further including i) enabling voicemail messages to be backed up remotely from the mobile device and ii) enabling devices other than the mobile device to access the backed up voicemail messages.

10. A mobile device, comprising:
one or more processors; and
memory operatively coupled to the one or more processors and storing computer-readable instructions that, when executed by the one or more processors, perform a method comprising the steps of:
establishing a connection to a hybrid telecommunications network, the connection comprising either a Wi-Fi connection or a cellular connection, the hybrid telecommunications network comprising loosely coupled network portions, the network portions including at least a mobile operator network and a VoIP (Voice over Internet Protocol) network,
receiving a notification of an incoming MMS (Multimedia Messaging Service) message from a remote service over the connection to the hybrid telecommunications network, the notification comprising a WAP Push message using the SMS (Short Message Service) protocol, and
determining from an identifier in a WAP Push message header if the MMS message is a visual voicemail (VVM) message, a VVM message comprising a voicemail that is included in a body of the MMS message and the identifier.

11. The mobile device of claim 10 in which the method further includes downloading the MMS message from the remote service using an HTTP (Hypertext Transfer Protocol) GET request.

12. The mobile device of claim 11 in which the method further includes storing the downloaded MMS message in a local VVM store if the incoming MMS message is determined to be a VVM message.

13. The mobile device of claim 12 in which the method further includes backing up the downloaded MMS message to a cloud-based VVM store if the incoming MMS message is determined to be a VVM message

14. The mobile device of claim 11 in which the method further includes storing the downloaded MMS message in a local messaging store if the incoming MMS message is determined to be a regular MMS message.

15. The mobile device of claim 11 in which the method further includes backing up the downloaded MMS message to a cloud-based messaging store if the incoming MMS message is determined to be a regular MMS message.

16. The mobile device of claim 10 in which the method further includes providing a notification of a new voicemail message on a graphical user interface supported by the mobile device.

17. The mobile device of claim 11 in which the method further includes displaying voicemail messages in a list on a graphical user interface supported by the mobile device.

18. A method for handling messages on a mobile device, comprising:
establishing a connection to a hybrid telecommunications network, the connection comprising either a Wi-Fi connection or cellular connection, the hybrid telecommunications network comprising loosely coupled network portions, the network portions including at least a mobile operator network and a VoIP (Voice over Internet Protocol) network;
receiving a WAP (Wireless Application Protocol) Push message over the connection using SMS (Short Messaging Service), the WAP Push message providing a notification of an incoming MMS (Multimedia Messaging System) message;
inspecting a WAP Push message header for an identifier that indicates if the MMS message contains a voicemail message;
downloading the MMS message by following a link provided in the WAP Push message; and
handling the downloaded MMS message with a visual voicemail application if the identifier in the WAP Push message header indicates that the MMS message contains a voicemail message.

19. The method of claim 18 further including handling the downloaded MMS message with a messaging application if the identifier in the WAP Push message header indicates that the MMS message is a regular MMS message.

20. The method of claim 18 further including providing an option to retry downloading the MMS message if a prior downloading attempt failed.
